(19) United States
(12) Patent Application Publication
(10) Pub. No.: US 2024/0327561 A1
(43) Pub. Date: Oct. 3, 2024

(54) FLUOROPOLYMER AND CYCLIC OLEFIN ALLOY

(71) Applicants: DAIKIN AMERICA, INC., Orangeburg, NY (US); DAIKIN INDUSTRIES, LTD., Osaka (JP)

(72) Inventors: Arthur W. Martin, Hockessin, DE (US); Halie Martin, Huntsville, AL (US)

(73) Assignees: DAIKIN AMERICA, INC., Orangeburg, NY (US); DAIKIN INDUSTRIES, LTD., Osaka (JP)

(21) Appl. No.: 18/742,603

(22) Filed: Jun. 13, 2024

Related U.S. Application Data
(63) Continuation of application No. PCT/JP2022/045989, filed on Dec. 14, 2022.
(60) Provisional application No. 63/289,389, filed on Dec. 14, 2021.

(51) Int. Cl. C08F 299/02; C08F 4/34

(52) U.S. Cl. CPC C08F 299/026; C08F 4/34

(57) ABSTRACT

Compatibilizers are disclosed that enable the formation of stable alloys of fluoropolymers with cyclic olefin copolymers (COC). The alloys are useful for many purposes, such as high frequency electronics. Methods of making the compatibilizer and the alloy are further provided.

### CROSS REFERENCE TO RELATED APPLICATIONS

This application is a Rule 53 (b) Continuation of International Application No. PCT/JP2022/045989 filed Dec. 14, 2022, claiming priority based on U.S. Provisional Patent Application No. 63/289,389 filed Dec. 14, 2021, the respective disclosures of which are incorporated herein by reference in their entirety.

### TECHNICAL FIELD

The present disclosure relates generally to fluoropolymer alloy compositions for use in high frequency electronics and other applications. Such fluoropolymer alloy compositions as well as compatibilizers for use therewith are provided.

### BACKGROUND ART

There is a demand for materials in the field of high frequency electronics related to “fifth generation of communication” (5G). These materials must have the capacity for information transmission and higher frequency for high speed processing. Materials such as epoxies and polyimides have been used for lower frequency applications, but they have not been able to overcome the stringent requirements to facilitate the high frequency range that 5G applications require. Other materials, such as liquid crystal polymer (LCP) and fluoropolymers display processing difficulties and adhesion problems. Linear polyolefins have excellent electrical properties but cannot withstand the processes for manufacturing electric circuits, including soldering and require temperature conditions exceeding 200° C.

Thus, there is a need in the art for a material with suitable electric, thermal, and mechanical properties for use in high frequency electronics applications.

### SUMMARY

The problems expounded above, as well as others, are addressed by the following inventions, although it is to be understood that not every embodiment of the inventions described herein will address each of the problems described above. The present disclosure provides a compatibilizer that facilitates the alloying of fluoropolymer with cyclic olefin copolymer (COC). Some embodiments of alloys including the compatibilizer have good electrical, thermal, and mechanical properties that make them useful in high-frequency electronic devices.

In a first aspect, a reaction mixture for making a compatibilizing agent is provided, the reaction mixture comprising: a first functional fluoropolymer; a first COC; a first reactive monomer; and a second reactive monomer.

The above summary presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF DRAWINGS

FIG. 1A scheme for producing an embodiment of the compatibilizer using reactive compounding of a dianhydride monomer, aromatic diamine, and PFA with end groups.

FIG. 2 Two steps in an alternative scheme for producing an embodiment of the compatibilizer.

FIG. 3A final step in the scheme shown in FIG. 2.

FIG. 4 An alternative final step in the scheme shown in FIG. 2.

FIG. 5 FTIR characterization of an embodiment of the grafted COC.

FIG. 6A zoomed in version of FIG. 5, showing the C=O from the cyclic anhydrides which proves the grafting increases with the increase of dianhydrides.

FIG. 7A plot of tensile modulus of various embodiments of the composition.

FIG. 8A plot of tensile strength of various embodiments of the composition.

FIG. 9A plot of elongation of various embodiments of the composition.

FIG. 10A plot of flexural strength of various embodiments of the composition.

FIG. 11A plot of flexural modulus of various embodiments of the composition.

FIG. 12A plot of % weight loss temperatures of various embodiments of the composition.

FIG. 13A plot of coefficient of thermal expansion of various embodiments of the composition.

### DESCRIPTION OF EMBODIMENTS

### Definitions

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

With reference to the use of the word(s) “comprise” or “comprises” or “comprising” in the foregoing description and/or in the following claims, unless the context requires otherwise, those words are used on the basis and clear understanding that they are to be interpreted inclusively, rather than exclusively, and that each of those words is to be so interpreted in construing the foregoing description and/or the following claims.

The term “consisting essentially of” means that, in addition to the recited elements, what is claimed may also contain other elements (steps, structures, ingredients, components, etc.) that do not adversely affect the operability of what is claimed for its intended purpose. Such addition of other elements that do not adversely affect the operability of what is claimed for its intended purpose would not constitute a material change in the basic and novel characteristics of what is claimed.

Terms such as “at least one of A and B” should be understood to mean “only A, only B, or both A and B.” The same construction should be applied to longer list (e.g., “at least one of A, B, and C”).

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

### Compatibilizing Agent

A compatibilizing agent is disclosed, some embodiments of which find use in making a compatibilized blend of a fluoropolymer and a COC. The compatibilizer has four basic groups, those being a fluoropolymer group, a COC group, a first monomer group, and a second monomer group.

A reaction mixture for making the compatibilizing agent is also disclosed. The reaction mixture comprises four constituents: a first functional fluoropolymer, a first COC, a first reactive monomer, and a second reactive monomer. The reaction mixture is intended to be further processed, as described below. Processing results in covalent bonding of the constituents.

Cyclic olefin copolymers (COCs) are copolymers of cyclic monomers such as 8,9,10-trinorborn-2-ene (norbornene) or 1,2,3,4,4a,5,8,8a-octahydro-1,4:5,8-dimethanonaphthalene (tetracyclododecene) with ethene. Other cyclic hydrocarbon monomers could be used as well. These polymers have desirable optical properties and are resistant to moisture. Moreover, they have excellent dielectric properties for electronic applications. COCs generally have a low dissipation factor and low conductivity. COC resins in pellet form are suited to standard polymer processing techniques such as single and twin screw extrusion, injection molding, injection blow molding and stretch blow molding, compression molding, extrusion coating, biaxial orientation, thermoforming and many others. COC have high dimensional stability with little change seen after processing.

In some embodiments of the reaction mixture the first COC comprises one or more of: maleic anhydride, cis-4-cyclohexene-1,2-dicarboxylic anhydride; trans-1,2,3,6-tetrahydrophthalic acid; 5-methyl-3A,4,7,7A-tetrahydro-isobenzofuran-1,3-dione; endo-bicyclo [2.2.2]oct-5-ene-2,3-dicarboxylic anhydride; cis-5-norbornene-endo-2,3-dicarboxylic anhydride; bicyclo [2.2.2]oct-7-ene-2,3,5,6-tetracarboxylic dianhydride; bicyclo [2.2.1]hept-5-ene-2,3-dicarboxylic anhydride; and 5-(2,5-dioxotetrahydrofuryl)-3-methyl-3-cyclohexene-1,2-dicarboxylic anhydride.

An example of a COC that is suitable for use in the reaction mixture is sold under the trade name COC TOPAS 6017s (TOPAS Advanced Polymers GmbH, Raunheim, Germany). COC TOPAS 6017 is an ethylene-norbornene copolymer (CAS 26007-43-2). COC TOPAS 6017s has properties listed in the manufacturer's technical data sheet as follows:

TABLE 1
Published Properties of TOPAS 6017S-04

| Property | Value Unit | | Test Standard |
|---|---|---|---|
| Density | 1020 | kg/m³ | ISO 1183 |
| Melt volume rate (MVR) | 1.5 | cm³/10 min | ISO 1133 |
| (260° C., 2.16 kg) | | | |
| Melt flow rate (MFR) | 1.4 | g/10 min | calculated |
| (260° C., 2.16 kg) | | | |
| Water absorption | 0.01% | | ISO 62 |
| (23° C.-sat) | | | |
| Tensile modulus | 440 | kpsi | ISO 527-3 |
| (1 mm/min) | | | |
| Tensile stress at | 8400 | psi | ISO 527-3 |
| break (5 mm/min) | | | |
| Tensile strain at | 2.4% | | ISO 527-3 |
| break (5 mm/min) | | | |
| Charpy impact | 7.1 | ft-lbs/in² | ISO 179/1eU |
| strength @ 23° C. | | | |
| Charpy notched impact | 0.8 | ft-lbs/in² | ISO 179/1eA |
| strength @ 23° C. | | | |
| Glass transition | 352° | F. | ISO 11357-1, -2, -3 |
| temperature | | | |
| (10° C./min) | | | |
| DTUL @ 0.45 MPa | 338° | F. | ISO 75-1, -2 |
| Vicat softening | 352° | F. | ISO 306 |
| temperature | | | |
| B50 (50° C./h 50N) | | | |

| | | |
|---|---|---|
| Flammability @1.6 | HB Class | UL94 |
| mm nom. thickn. | | |
| Relative | 2.35 — | IEC 60250 |
| permittivity | | |
| at 1-10 kHz | | |
| Relative | 2.30 — | IEC 60250 |
| permittivity | | |
| at 1 GHz | | |
| Dissipation factor | 6.0E−05 — | IEC 60250 |
| at 1 GHz | | |
| Volume | >1E14 ohm × m | IEC 60093 |
| resistivity | | |
| Comparative | >600 | IEC 60112 |
| tracking | | |
| index CTI | | |
| Deg. of light | 91.0% | ISO 13468-2 |
| transmission | | |
| Refractive index | 1.53 — | ISO 489 |
| (589 nm, 25° C.) | | |

The reaction mixture can contain a functionalized COC or a COC that has not been functionalized. The functionalized COC comprises a functional group. The functional group participates in the reaction with one or more of the other constituents. As used herein, “functional group” refers to any reactive group that is capable of forming a chemical bond, for instance, by covalent, hydrogen, or ionic bonding to the COC. Suitable functional groups include carboxyl, amine, anhydride, hydroxyl, epoxy, sulfhydryl, siloxane, and oxazoline. Some embodiments of the functionalized COC may have multiple functional groups, including any combination of one or more of carboxyl, amine, anhydride, hydroxyl, epoxy, sulfhydryl, siloxane, and oxazoline.

In some embodiments of the reaction mixture the first functionalized COC is an anhydride. Anhydrides have the advantages of reacting with alcohols to form esters and reacting with amines to form amides. The functionalized COC may be a dianhydride (i.e., having two anhydride groups). Dianhydrides have the advantage of providing more reactive groups. In some embodiments of the reaction mixture the second monomer is a dicarboxylic anhydride. The COC anhydride may be a fluorinated anhydride, such as 4,4′-(hexafluoroisopropylidene) diphthalic anhydride (6FDA). In some embodiments of the reaction the anhydride is an unsaturated cyclic dianhydride. In a specific embodiment the functionalized first COC is a product of reacting bicyclo [2.2.1]hept-5-ene-2,3-dicarboxylic anhydride (BCDA) with a COC. In a more specific embodiment the functionalized first COC is a product of reacting BCDA with TOPAS 6017s. In another specific embodiment the functionalized first COC is a product of reacting BCDA with TOPAS 6015s.

The functionalized first COC may be prepared by various methods. For example, the anhydride may be grafted to the COC catalyzed by a peroxide-catalyzed reaction. Suitable peroxide catalysts include dialkyl peroxide. Some embodiments of the reaction mixture comprise a peroxide catalyst capable of catalyzing functionalization of the first COC by an anhydride, particularly when the first COC fraction includes COC that is not functionalized. In other embodiments the COC may be functionalized prior to combination with the other components of the reaction mixture.

In some embodiments of the reaction mixture the first monomer is an amine. Amine monomers have several advantages, one of which is the ability of amines to reaction with anhydrides to form amides. In further embodiments the first monomer is a diamine, which has the advantage of multiple reactive amine groups. In a specific embodiment of the reaction mixture the first monomer is a dianiline, such as 4,4′-oxydianiline.

In some embodiments of the reaction mixture the first monomer is present at 0.1-25% w/w. In some embodiments of the reaction mixture the first monomer is present at 0.5-10% w/w. In further embodiments of the reaction mixture the first monomer is present at 0.6-5.0, 0.7-4.0, 0.8-3.0, 0.9-2.5, 1.0-2.4, 1.1-2.3, 1.2-2.2, 1.3-2.1, 1.4-2.0, 1.4, 1.5, 1.6, 1.7. 1.8, 1.9, and 2.0% w/w. In a specific embodiment the first monomer is present at 1.45% w/w. In another specific embodiment the first monomer is present at 2.0% w/w.

In some embodiments of the reaction mixture the second monomer is an anhydride. Anhydrides have the advantages in the second monomer as described above for the functionalized first COC, and the anhydrides disclosed as suitable for functionalization of the first COC are also suitable as the second monomer. In a specific embodiment the second monomer is BCDA. In another specific embodiment the second monomer is 6FDA. In another specific embodiment the second monomer is present as BCDA and 6FDA.

In some embodiments of the reaction mixture the second monomer is present from 1-25% w/w. In some embodiments of the reaction mixture the second monomer is present at 1.1-20, 1.2-10, 1.3-9, 1.4-8, 1.5-7, 1.6-6, 1.7-5, 1.8-4.5, 1.9-4, 2.0-3.6, 2.1-3.5, 2.2-3.4, 2.3-3.3, 2.4-3.2, or 2.5-3.1% w/w. In specific embodiments of the reaction mixture the second monomer is present at 2.5, 2.6, 2.7. 2.8, 2.9, 3.0, or 3.1% w/w.

The first and second monomers may in some cases be present at near-equivalent molar ratios. In some embodiments of the reaction mixture the first and second monomers are present at a molar ratio of 0.5-2.0. In further embodiments of the reaction mixture the first and second monomers are present at a molar ratio of 0.6-1.8, 0.7-1.6, 0.8-1.4, or 0.9-1.2. In a specific embodiment the first and second monomers are present at a molar ratio of 1. A monomer fraction may be present, comprising the first and second monomers (and potentially additional monomers of the same nature) in the reaction mixture. In some embodiments of the reaction mixture the monomer fraction makes up no more than 5% w/w of the mixture. In further embodiments of the reaction mixture the monomer fraction makes up 4-5, 4.1-4.9, 4.2-4.8, 4.3-4.7, or 4.4-4.6% w/w of the mixture. In specific embodiments of the reaction mixture the monomer fraction makes up 4.5-4.6% w/w of the mixture.

Ideally the first COC will have mechanical and/or electrical properties suitable for high frequency electronic applications. In some embodiments of the reaction mixture the first COC has a tensile strength ≥25 MPa. In further embodiments of the reaction mixture the first COC has a tensile strength ≥30, 35, 40, 45, 50, 51, 52, and 53 MPa. In a specific embodiment of the reaction mixture the first COC has a tensile strength of 54 MPa. In some embodiments of the reaction mixture the first COC has a Young's modulus 200 MPa. In further embodiments of the reaction mixture the first COC has a Young's modulus ≥250, 300, 350, 400, 450, 460, 470, and 480 MPa. In a specific embodiment of the reaction mixture the first COC has a Young's modulus of 481. In some embodiments of the reaction mixture the first COC has a flexural modulus ≥1000 MPa. In further embodiments of the reaction mixture the first COC has a flexural modulus ≥1100, 1200, 1300, 1400, 1500, 1600, 1700, 1800, 1900, 2000, 2100, 2200, 2300, 2400, and 2500. In a specific embodiment of the reaction mixture the first COC has a flexural modulus of 2530. In some embodiments of the reaction mixture the first COC has a flexural strength ≥50 MPa. In further embodiments of the reaction mixture the first COC has flexural strength ≥55, 60, 65, 70, 71, 72, 73, 74, and 75 MPa. In a specific embodiment of the reaction mixture the first COC has flexural strength of 76 MPa. In some embodiments of the reaction mixture the first COC has a flexural load ≥50 N. In further embodiments of the reaction mixture the first COC has a flexural load ≥60, 70, 80, 90, 100, 110, 120, 121, 122, 123, 124, and 125 N. In a specific embodiment of the reaction mixture the first COC has a flexural load of 126 N. In some embodiments of the reaction mixture the first COC has a coefficient of thermal expansion ≤100 μm/(m° C.). All of the foregoing mechanical properties refer to measurements made by ATSM D638 and ASTM D790 standards.

In further embodiments of the reaction mixture the first COC has a coefficient of thermal expansion (CTE) ≤90, 80, 70, 60, 50, 49, 48, 47, 46, 45, 44, 43, 42, 41, and 40 μm/(m° C.). In a specific embodiment of the reaction mixture the first COC has a coefficient of thermal expansion of 39 μm/(m° C.). In some embodiments of the reaction mixture the first COC has a dielectric constant ≥2.10. In further embodiments of the reaction mixture the first COC has a dielectric constant ≥2.15, 2.20, 2.25, 2.30, 2.31, 2.32, and 2.33. In a specific embodiment of the reaction mixture the first COC has a dielectric constant of 2.335. In some embodiments of the reaction mixture the first COC has dissipation factor ≤0.001. In further embodiments of the reaction mixture the first COC has dissipation factor ≤0.0009, 0.0008, 0.0007, 0.0006, 0.0005, 0.00049, 0.00048. In a specific embodiment of the reaction mixture the first COC has dissipation factor of 0.00047. In some embodiments of the reaction mixture the first COC has a 1% weight loss temperature of ≥350° C. In further embodiments of the reaction mixture the first COC has a 1% weight loss temperature of ≥360, 370, 380, 390, 391, 392, and 393° C. In a specific embodiment of the reaction mixture the first COC has a 1% weight loss temperature of 394° C. In some embodiments of the reaction mixture the first COC has a 5% weight loss temperature of ≥400° C. In further embodiments of the reaction mixture the first COC has a 5% weight loss temperature of ≥405, 410, 415, 416, and 417° C. In a specific embodiment of the reaction mixture the first COC has a 5% weight loss temperature of 418° C. In some embodiments of the reaction mixture the first COC has a melt flow rate ≤200 (g/10 min) at 297° C. In further embodiments of the reaction mixture the first COC has a melt flow rate ≤190, 180, 170, 160, 150, 140, 130, 120, 110, 109, 108, 107, 106, 105, 104, 103, 102, and 101 g/(10 min). In a specific embodiment of the reaction mixture the first COC has a melt flow rate of 100.6 g/(10 min). Melt flow rate was measured using Tinius Olsen Melt Indexer MP1200M (MFR) according to the following method, and where reference is made to MFR it should be assumed to mean MFR as measured by this method unless clearly stated otherwise: approximately 5 g of the material is loaded into the barrel of the melt flow apparatus, which has been heated to a temperature of 297° C.; after 300 seconds, a 5 kg weight is applied to a plunger and the molten material is forced through the die; a timed extrudate is collected and weighed; melt flow rate values are calculated in g/10 min. Where reference is made to a CTE, it is to be assumed to refer to CTE as measured by this method unless clearly stated otherwise.
1: Force 0.100 N
2: Equilibrate at 35.00° C.
3: Isothermal for 5.00 min
4: Mark end of cycle 0
5: Isothermal for 5.00 min
6: Ramp 5.00° C./min to 100.00° C.
7: Isothermal for 3.00 min
8: Mark end of cycle 1
9: Ramp 10.00° C./min to 0.00° C.
10: Mark end of cycle 2
11: Ramp 5.00° C./min to 200.00° C.
12: End of method

In some embodiments of the reaction mixture the first fluoropolymer has been sheared or otherwise functionalized. Shearing creates reactive end groups, such as COF and carboxylic acid groups.

The first fluoropolymer in the reaction mixture will preferably have good thermal resistance, good dielectric properties, or both. In some embodiments of the reaction mixture the first fluoropolymer is one or more of: perfluoroalkoxy alkane (PFA), fluorinated ethylene propylene (FEP), polytetrafluoroethylene (PTFE), ethylene tetra-fluoroethylene (ETFE), polyvinylidene fluoride (PVDF), a terpolymer of ethylene, tetrafluoroethylene, hexafluoropropylene (EFEP), ethylene chlorotrifluoroethylene (ECTFE), polychlorotrifluoroethylene (PCTFE), terpolymer of tetrafluoroethylene-hexafluoropropylene-vinylidene fluoride (THV), tetrafluoroethylene and vinylidene fluoride copolymer (VT), and combinations of any of the foregoing.

The first fluoropolymer may be present in the reaction mixture from 1-99% w/w. The first fluoropolymer will preferably make up a majority of the compatibilizer composition by weight (at least 50% w/w). Some embodiments of the reaction mixture are at least 55, 60, 65, 70, 75, 76, 77, 78,79, or 80% w/w the first fluoropolymer. In further embodiments of the reaction mixture the first fluoropolymer is present at 65-95, 70-90, 71-89, 72-88, 73-87, 74-86, 75-85, or 76-82% w/w. In specific embodiments the first fluoropolymer is present at 75, 76, 77, 78, 79, 80, or 81% w/w.

### Methods of Making the Compatibilizing Agent

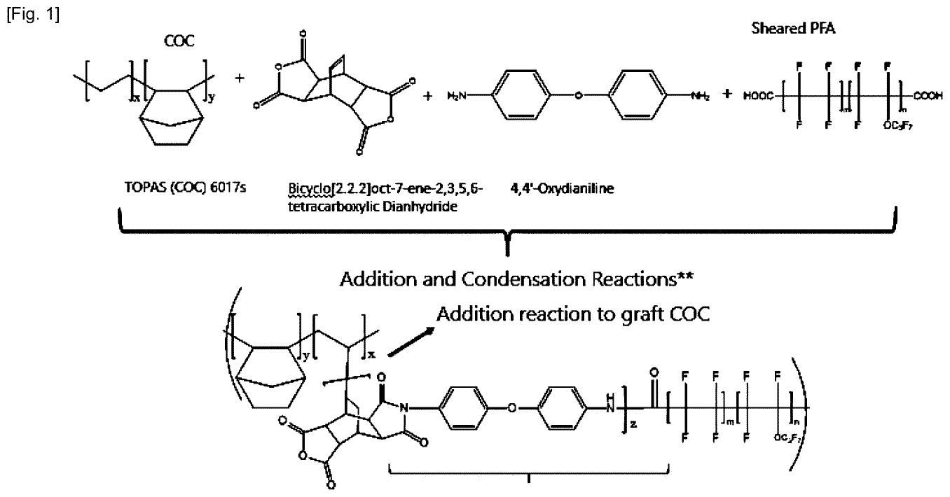

A method of making the compatibilizing agent is disclosed. Some embodiments of the method find use in making one or more embodiments of the compatibilizing agent described above, although not every embodiment of the method will be useful in making every embodiment of the compatibilizing agent. A general embodiment of the method comprises heating the reaction mixture described above (for example, the first fluoropolymer, the first COC, the first reactive monomer, and the second reactive monomer) sufficiently to melt at least the first fluoropolymer and the first COC. Heating facilitates mixing of solid components by melting or reducing their viscosity, and in some instances results in the functionalization of the first COC. In some embodiments, the components of the reaction mixture can be mixed in an extruder, such as a twin-screw extruder, and heated. In such embodiments the heat of the extruder initiates the chemical reaction. In some embodiments, the reaction mixture is heated to a temperature of 315° C. or greater. In further embodiments, the reaction mixture is heated to a temperature of 330° C. or greater. In still further embodiments, the reaction mixture is heated to a temperature of 350° C. FIG. 1 shows an example of a scheme for making the compatibilizing agent according to this embodiment. As shown in FIG. 1, the preparation of the compatibilizing agent occurs via the combination of an addition and condensation reaction in the extruder.

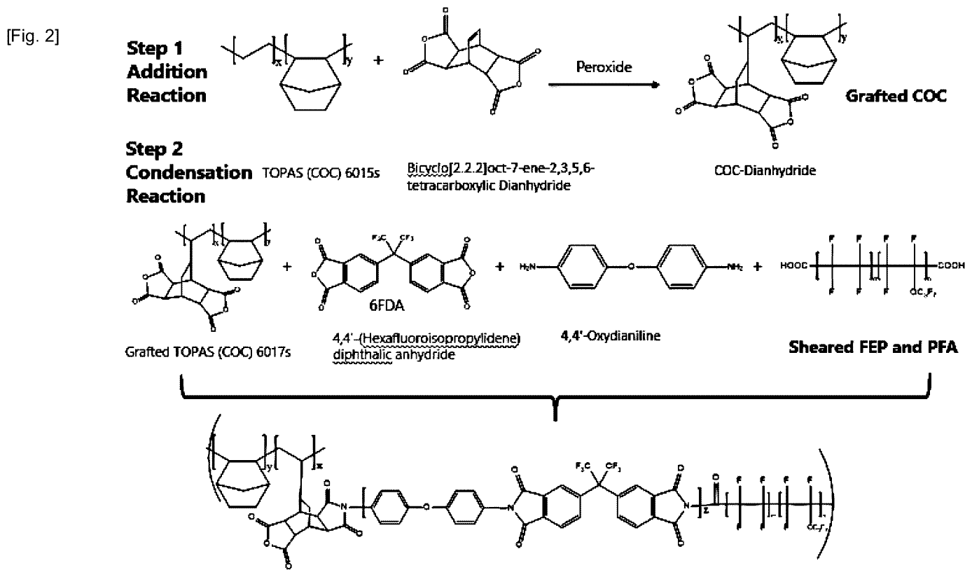

An alternative general method of making the compatibilizing agent comprises reacting an anhydride monomer with a first functional fluoropolymer to produce a fluoropolymer dianhydride, and reacting the fluoropolymer dianhydride with a functional COC and a diamine monomer to produce the compatibilizing agent. FIG. 2 shows an example of a scheme for making the compatibilizing agent according to this embodiment. As shown in FIG. 2, the functional COC can be made by reacting an anhydride, such as, for example, bicyclo [2.2.1]hept-5-ene-2,3-dicarboxylic anhydride, with a non-functional cyclic olefin polymer in the presence of a peroxide catalyst. As discussed above, the anhydride may be grafted to the COC by a peroxide-catalyzed reaction. A suitable peroxide catalyst includes dialkyl peroxide. Without being bound by any particular theory, it is believed that this addition reaction increases the reactive groups available to react with other components of the compatibilizing agents. In the second step of the method, which is a condensation reaction, the functional COC can be reacted with the fluoropolymer dianhydride and the diamine monomer to form the compatibilizing agent.

### Compatibilizer Compositions

In some embodiments, a reactive polymer compatibilizer is disclosed that is the product of any of the methods described above. The reactive polymer compatibilizer can be effective to form a thermoplastic polymer alloy of fluoropolymer and COC. In some embodiments, the reactive polymer compatibilizer is used in an amount of 1-99% w/w to form the thermoplastic polymer alloy. In further embodiments, the reactive polymer compatibilizer is used in an amount of 5-30% w/w. For example, the reactive polymer compatibilizer may be used in an amount of 30, 29, 28, 27, 26, 25, 24, 23, 22, 21, 20, 19, 18, 17, 16, 15, 14, 13, 12, 11, 10, 9, 8, 7, 6 or 5% w/w. In a specific embodiment, the reactive polymer compatibilizer is used in an amount of 10% w/w.

In further embodiments, the present disclosure provides reactive polymer compatibilizers that include a COC group covalently bound to a linking polymer of at least one heterodimer including a dianhydride monomer and a diamine monomer. In this embodiment, the linking polymer is covalently bonded to a fluoropolymer group.

In a specific embodiment, the reactive polymer compatibilizer may be a compound of formula (I):

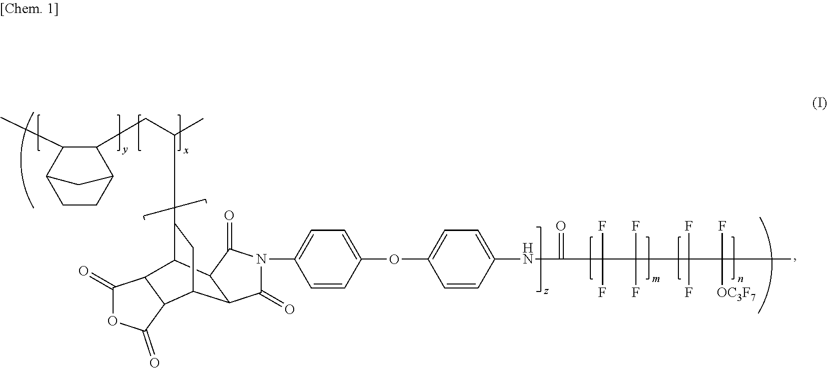

where m, n, x, y, and z are each independently selected from an integer ≥1 and the subunits of which can be in any order.

In another specific embodiment, the reactive polymer compatibilizer may be a compound of formula (II):

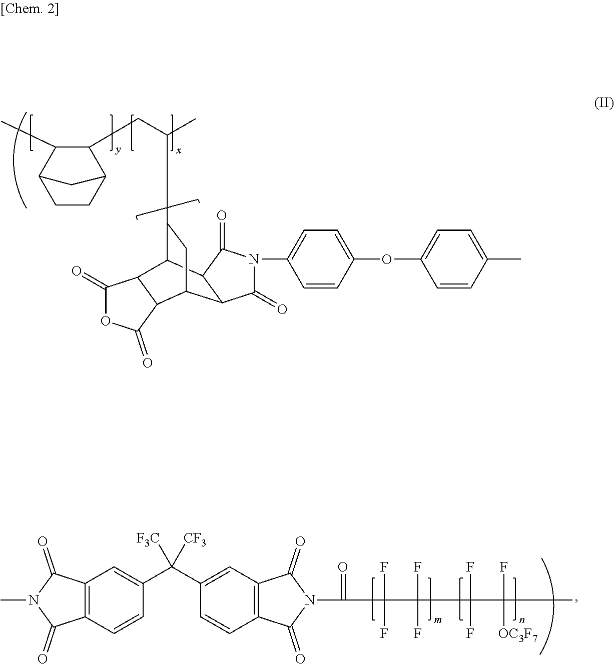

where m, n, x, y, and z are each independently selected from an integer ≥1 and the subunits of which can be in any order.

### Alloys of Fluoropolymer and Cyclic Olefin Copolymer

A thermoplastic polymer alloy of fluoropolymer and COC is disclosed, having many of desirable characteristics of both fluoropolymers and COC. Although these two components are not normally miscible or compatible, they can be effectively compatibilized using embodiments of the compatibilizer described above. In a general embodiment the alloy comprises a second fluoropolymer (which might or might not be the same fluoropolymer used to produce the compatibilizer), a second COC (which might or might not be the same COC used to produce the compatibilizer), and the compatibilizing agent. Without wishing to be bound by a hypothetical model, it is believed that the second fluoropolymer and the second COC are chemically unchanged during the formation of the alloy.

Ideally the second COC will have mechanical and/or electrical properties suitable for high frequently electronic applications. In some embodiments of the reaction mixture the second COC has a tensile strength ≥25 MPa. In further embodiments of the reaction mixture the second COC has a tensile strength ≥30, 35, 40, 45, 50, 51, 52, and 53 MPa. In a specific embodiment of the reaction mixture the second COC has a tensile strength of 54 MPa. In some embodiments of the reaction mixture the second COC has a Young's modulus ≥200 MPa. In further embodiments of the reaction mixture the second COC has a Young's modulus ≥250, 300, 350, 400, 450, 460, 470, and 480 MPa. In a specific embodiment of the reaction mixture the second COC has a Young's modulus of 481. In some embodiments of the reaction mixture the second COC has a flexural modulus ≥1000 MPa. In further embodiments of the reaction mixture the second COC has a flexural modulus ≥1100, 1200, 1300, 1400, 1500, 1600, 1700, 1800, 1900, 2000, 2100, 2200, 2300, 2400, and 2500. In a specific embodiment of the reaction mixture the second COC has a flexural modulus of 2530. In some embodiments of the reaction mixture the second COC has a flexural strength ≥50 MPa. In further embodiments of the reaction mixture the second COC has flexural strength ≥55, 60, 65, 70, 71, 72, 73, 74, and 75 MPa. In a specific embodiment of the reaction mixture the second COC has flexural strength of 76 MPa. In some embodiments of the reaction mixture the second COC has a flexural load ≥50 N. In further embodiments of the reaction mixture the second COC has a flexural load ≥60, 70, 80, 90, 100, 110, 120, 121, 122, 123, 124, and 125 N. In a specific embodiment of the reaction mixture the second COC has a flexural load of 126 N. In some embodiments of the reaction mixture the second COC has a coefficient of thermal expansion ≤100 μm/(m° C.). All of the foregoing mechanical properties refer to measurements made by ATSM D638 and ASTM D790 standards.

In further embodiments of the reaction mixture the second COC has a coefficient of thermal expansion ≤90, 80, 70, 60, 50, 49, 48, 47, 46, 45, 44, 43, 42, 41, and 40 μm/(m° C.). In a specific embodiment of the reaction mixture the second COC has a coefficient of thermal expansion of 39 μm/(m° C.). In some embodiments of the reaction mixture the second COC has a dielectric constant ≥2.10. In further embodiments of the reaction mixture the second COC has a dielectric constant ≥2.15, 2.20, 2.25, 2.30, 2.31, 2.32, and 2.33. In a specific embodiment of the reaction mixture the second COC has a dielectric constant of 2.335. In some embodiments of the reaction mixture the second COC has dissipation factor ≤0.001. In further embodiments of the reaction mixture the second COC has dissipation factor ≤0.0009, 0.0008, 0.0007, 0.0006, 0.0005, 0.00049, 0.00048. In a specific embodiment of the reaction mixture the second COC has dissipation factor of 0.00047. In some embodiments of the reaction mixture the second COC has a 1% weight loss temperature of ≥350° C. In further embodiments of the reaction mixture the second COC has a 1% weight loss temperature of ≥360, 370, 380, 390, 391, 392, and 393° C. In a specific embodiment of the reaction mixture the second COC has a 1% weight loss temperature of 394° C. In some embodiments of the reaction mixture the second COC has a 5% weight loss temperature of ≥400° C. In further embodiments of the reaction mixture the second COC has a 5% weight loss temperature of ≥405, 410, 415, 416, and 417° C. In a specific embodiment of the reaction mixture the second COC has a 5% weight loss temperature of 418° C. In some embodiments of the reaction mixture the second COC has a melt flow rate ≤200 (g/10 min) at 297° C. In further embodiments of the reaction mixture the second COC has a melt flow rate ≤190, 180, 170, 160, 150, 140, 130, 120, 110, 109, 108, 107, 106, 105, 104, 103, 102, and 101 g/(10 min). In a specific embodiment of the reaction mixture the second COC has a melt flow rate of 100.6 g/(10 min). Melt flow rate was determined according to the method provided above.

In some embodiments of the alloy the second COC is a non-functional COC. Functional groups might not be necessary in embodiments of the alloy in which the second COC does not chemically react with other components during the alloying process. In some embodiments of the alloy the second COC is the same as the first COC, or the second COC is a less functional version of the first COC. The less functional version of the first COC might have fewer functional groups or no functional groups.

In some embodiments of the reaction mixture the second COC comprises one or more of: maleic anhydride, cis-4-cyclohexene-1,2-dicarboxylic anhydride; trans-1,2,3,6-tetrahydrophthalic acid; 5-methyl-3A,4,7,7A-tetrahydro-isobenzofuran-1,3-dione; endo-bicyclo [2.2.2]oct-5-ene-2,3-dicarboxylic anhydride; cis-5-norbornene-endo-2,3-dicarboxylic anhydride; bicyclo [2.2.2]oct-7-ene-2,3,5,6-tetracarboxylic dianhydride; bicyclo [2.2.1]hept-5-ene-2,3-dicarboxylic anhydride; and 5-(2,5-dioxotetrahydrofuryl)-3-methyl-3-cyclohexene-1,2-dicarboxylic anhydride. In a specific embodiment of the alloy the second COC is TOPAS 6017s (TOPAS Advanced Polymers GmbH, Raunheim, Germany).

In some embodiments of the alloy the second fluoropolymer is not a sheared fluoropolymer. In some embodiments of the alloy the second fluoropolymer lacks a functional group.

In some embodiments of the alloy the second fluoropolymer comprises at least one of: PFA, FEP, PTFE, ETFE, PVDF, EFEP, ECTFE, PCTFE, THV, and VT. Combinations of any two or more of the foregoing may be present in a second fluoropolymer fraction. In specific embodiments of the alloy, the second fluoropolymer is PFA, FEP, or PTFE.

Some embodiments of the alloy comprise a third fluoropolymer. In some embodiments of the alloy the third fluoropolymer may be any fluoropolymer taught to be suitable as the second fluoropolymer herein.

In some embodiments of the alloy the compatibilizing agent is any of the compatibilizing agents described above.

In some embodiments of the alloy the first functional fluoropolymer is a functionalized version of the second functional fluoropolymer. In some such embodiments the first functional fluoropolymer may be the second fluoropolymer, having been previously sheared to create functional groups.

Additional compatibilizing agents may be added to the alloy. Bis(oxazoline) compatibilizers are an example of a suitable class of second compatibilizing agent. Some embodiments of the alloy comprise a second compatibilizing agent selected from: 1,4-bis (4,5-dihydro-2-oxazolyl) benzene and 1,3-bis (4,5-dihydro-2-oxazolyl) benzene. Some embodiments of the alloy comprise about 0.1-10% w/w of the second compatibilizing agent. Further embodiments of the alloy contain 0.2-9, 0.3-8, 0.4-7, 0.5-6, 0.6-5, 0.7-4, 0.8-3, and 0.9-2% w/w of the second compatibilizing agent. A specific embodiment of the alloy contains 1% w/w of the second compatibilizing agent. Some embodiments of the alloy comprise a filler with a low dissipation factor to modulate the electrical properties of the alloy. Examples of suitable fillers include Al₂O₃, and SiO₂. In some embodiments of the alloy the filler is present at 0.1-40% w/w. In further embodiments of the alloy the filler is present at 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40% w/w.

Ideally the alloy will have mechanical and/or electrical properties suitable for high frequency electronic applications. Some embodiments of the alloy have a 1% w/w loss temperature of at least 300° C. Further embodiments of the alloy have a 1% w/w loss temperature of at least 310, 320, 330, 340, 350, 360, 370, 380, 390, 400, and 410° C. Further embodiments of the alloy have a 1% w/w loss temperature of 330-420° C. Some embodiments of the alloy have a 5% w/w loss temperature of at least 390° C. Further embodiments of the alloy have a 5% w/w loss temperature of at least 400, 410, 420, 430, 440, 441, 442, 443, 444, 445, 446, and 447° C. Further embodiments of the alloy have a 5% w/w loss temperature of 405-450° C. The percent loss at a given temperature was measured on a TA Instruments Thermogravimetric Analyzer Q500 (TA Instruments, Newcastle, DE) using the following method. Reference to percent loss at a given temperature should be assumed to mean as measured by this method unless clearly stated otherwise.
1: Equilibrate at 40.00° C.
2: Ramp 10.00° C./min to 800.00° C.
3: Mark end of cycle 1
4: End of method

Ideally the alloy is sufficiently resistant to strain under load for high frequency electronics applications. In some embodiments, the alloy has a Young's modulus ≥140 MPa. In further embodiments, the alloy has a Young's modulus ≥225, 250, 260, 280, 300, 350, 400, 410, 420, 430, 450, 470, 475, and 480. For example, in some embodiments, the alloy has a Young's modulus of 140 MPa to 480 MPa. In further embodiments, the alloy has a Young's modulus of 225 MPa to 450 MPa. In further embodiments, the alloy has a Young's modulus of 410-472. In a specific embodiment, the alloy has a Young's modulus of 410 MPa. In another specific embodiment, the alloy has a Young's modulus of 430 MPa. In yet another specific embodiment, the alloy has a Young's modulus of 472 MPa. Ideally the alloy has a high enough tensile strength to perform well for high frequency electronics applications. Some embodiments of the alloy have a tensile strength of at least 24 MPa. In further embodiments, the alloy has a tensile strength of ≥25, 30, 35, 38, 40, 45, 48, 50, 52, and 54 MPa. For instance, in some embodiments, the alloy has a tensile strength of 24 MPa to 50 MPa. In further embodiments, the alloy has a tensile strength of 24 MPa to 48 MPa. In a specific embodiment, the alloy has a tensile strength of 41 MPa. In another specific embodiment, the alloy has a tensile strength of 48 MPa. Ideally the alloy is sufficiently resistant to elongation to perform well for high frequency electronics applications. Some embodiments of the alloy have an elongation of less than 20%. In further embodiments, the alloy has an elongation of less than or equal to 19%, 18%, 17%, and 16%. For example, the alloy may have an elongation of 18.5%. In another specific embodiment, the alloy may have an elongation of 17.2%. In still further embodiments, the alloy has an elongation of no more than the elongation of the second COC.

Ideally the alloy is sufficiently resistant to flexion to perform well for high frequency electronics applications. In some embodiments, the alloy has a flexural modulus of at least 500 MPa. In further embodiments, the alloy has a flexural modulus of at least 1000 MPa. In still further embodiments, the alloy has a flexural modulus of at least 1500 MPa. For example, in some embodiments, the alloy has a flexural modulus of at least 500, 700, 900, 1000, 1100, 1500, 1800, 1900, and 2000 MPa. In a specific embodiment, the alloy has a flexural modulus of 1823 MPA. In some embodiments, the alloy has a flexural strength of at least 20 MPa. In further embodiments, the alloy has a flexural strength of at least 30, 35, 40, 45, 50, and 55 MPa. In a specific embodiment, the alloy has a flexural strength of 34 MPa. In another specific embodiment, the alloy has a flexural strength of 50 MPa. In some embodiments, the alloy has a flexural load of at least 40 N. In further embodiments, the alloy has a flexural load of at least 55, 60, 65, 70, 75, 80, 85, and 90 N. In a specific embodiment, the alloy has a flexural load of 58 N. In another specific embodiment, the alloy has a flexural load of 84 N. The foregoing mechanical properties refer to measurements made by ATSM D638 and ASTM D790 standards.

Ideally the alloy is sufficiently resistant to thermal expansion to perform well for high frequency electronics applications. Some embodiments of the alloy have a coefficient of thermal expansion of less than 200 μm/(m° C.). In further embodiments, the alloy has a coefficient of thermal expansion of less than 225 μm/(m° C.). For example, in some embodiments, the alloy has a coefficient of thermal expansion of less than 220, 175, 150, 125, 100, 90, 80, 75, 70, 65, 60, and 55 μm/(m° C.). In a specific embodiment, the alloy has a coefficient of thermal expansion of 66 μm/(m° C.). In another specific embodiment, the alloy has a coefficient of thermal expansion of 74 μm/(m° C.). Some embodiments of the alloy have a coefficient of thermal expansion that is less than the second fluoropolymer's coefficient of thermal expansion.

Ideally the alloy has a dielectric constant suitable for high frequency electronics applications. Some embodiments of the alloy have a dielectric constant greater than 2.1. In further embodiments, the alloy has a dielectric constant greater than 2.15, 2.16, 2.17, 2.18, 2.19, 2.0, 2.1 2.2, 2.25, and 2.3. In specific embodiments, the alloy has a dielectric constant of 2.17. In another specific embodiment, the alloy has a dielectric constant of 2.3. Ideally the alloy has a dissipation factor suitable for high frequency electronics applications. Some embodiments of the alloy have a dissipation factor less than 0.001. In further embodiments, the alloy has a dissipation factor less than 0.0009. In still further embodiments, the alloy has a dissipation factor less than 0.0008. In yet further embodiments, the alloy has a dissipation factor less than 0.0007. In some embodiments of the alloy the alloy has a dissipation factor less than that of the pure second fluoropolymer. For each sample, a sample thickness was measured at four to five locations using a digital caliper and averaged. The samples were then inserted into the cavity. Measurements were made using Keysight P9374A PNA sand NIST SplitC software. In samples having defects, the best area was used to cover the cavity opening. Dielectric constant and dielectric loss factor were measured at 16 GHz. References to dielectric constant and dielectric loss factor values refer to values obtained by this method unless clearly stated otherwise.

### Method of Making an Alloy

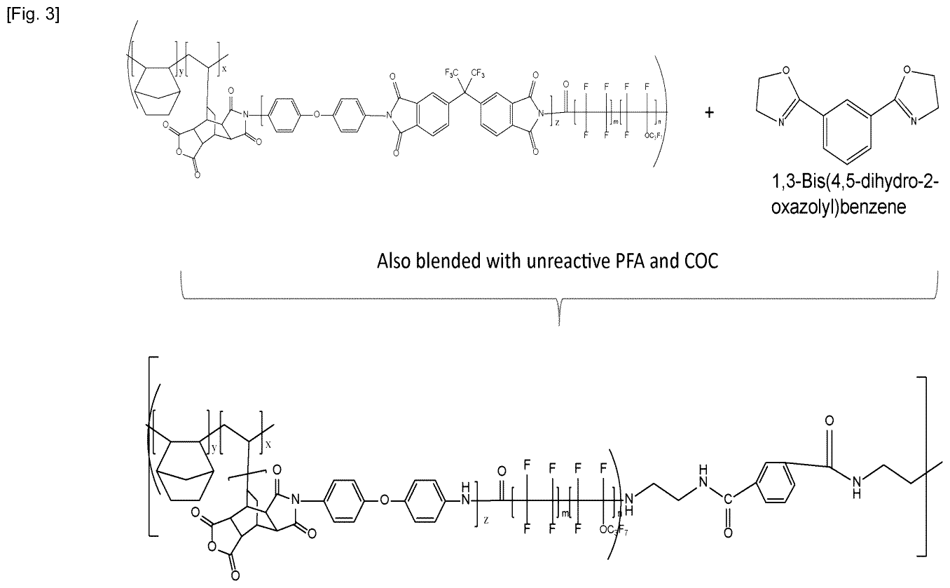

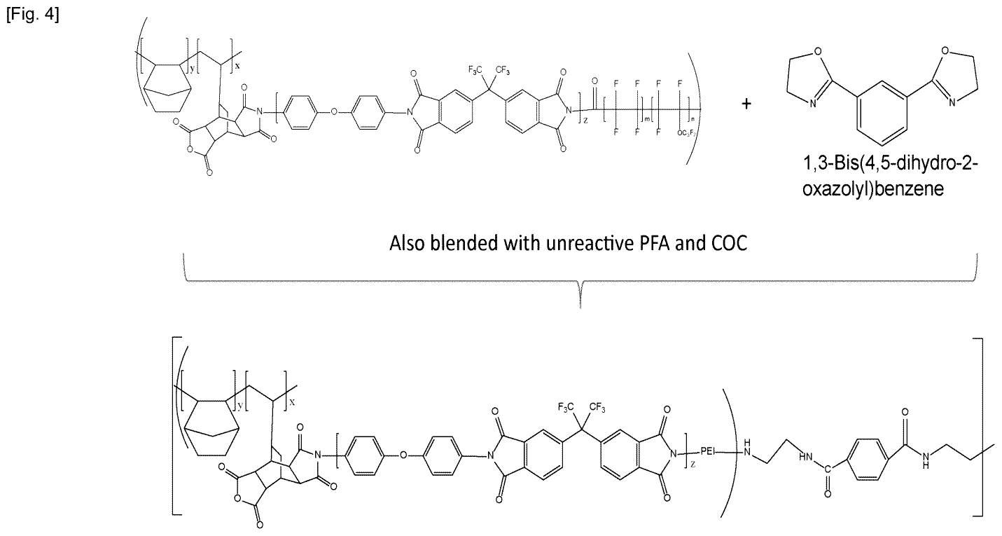

A method of forming an alloy of a fluoropolymer and a COC is disclosed. Some embodiments of the method find use in producing some embodiments of the alloy disclosed above, although not every embodiment of the method will be useful to produce every embodiment of the alloy. A general embodiment of the method comprises blending a second fluoropolymer, a compatibilizing agent, and a second cyclic olefin at a temperature sufficient to melt at least the second fluoropolymer and second COC. Once the fluoropolymer and COC are melted, they then can be alloyed in the presence of the compatibilizer (such as those described above). The reactive compatibilizer can be used to lower the interfacial surface tension between the two dissimilar polymers, i.e., the fluoropolymer and the COC, in order to form a miscible blend. FIGS. 3 and 4 show exemplary schemes for forming the alloy according to this embodiment. As shown in FIGS. 3 and 4, the second compatibilizing agent, the second fluoropolymer, and the second COC are blended in the presence of the compatibilizer to form an alloy of the fluoropolymer and the COC.

In some embodiments of the method, the blending is performed in an extruder, such as a twin-screw extruder. In further embodiments, the blending is performed at a temperature of 315° C. or greater. In still further embodiments, the blending is performed at a temperature of 330° C. or greater. In still further embodiments, the blending is performed at a temperature of 350° C.

In some embodiments of the methods of forming the alloy, the second fluoropolymer can be any of those described above in the preceding sections. For example, in some embodiments of the method, the second fluoropolymer comprises at least one of: perfluoroalkoxy alkane (PFA), fluorinated ethylene propylene (FEP), polytetrafluoroethylene (PTFE), ethylene tetra-fluoroethylene (ETFE), polyvinylidene fluoride (PVDF), and a terpolymer of ethylene, tetrafluoroethylene, hexafluoropropylene (EFEP), ethylene chlorotrifluoroethylene (ECTFE), polychlorotrifluoroethylene (PCTFE), terpolymer of tetrafluoroethylene-hexafluoropropylene-vinylidene fluoride (THV), and tetrafluoroethylene and vinylidene fluoride copolymer (VT). In specific embodiments, such as those shown in FIGS. 3 and 4, the second fluoropolymer is PFA. In another specific embodiment, the second fluoropolymer is FEP. In yet another specific embodiment, the second fluoropolymer is PTFE.

Ideally the COC will have mechanical properties suitable for use in high frequency electronics applications. In some embodiments of the methods of forming the alloy, the second COC can be any of those described above in the preceding sections. For instance, in some embodiments, the second COC comprises one or more of: maleic anhydride, cis-4-cyclohexene-1,2-dicarboxylic anhydride; trans-1,2,3,6-tetrahydrophthalic acid; 5-methyl-3A,4,7,7A-tetrahydro-isobenzofuran-1,3-dione; endo-bicyclo [2.2.2] oct-5-ene-2,3-dicarboxylic anhydride; cis-5-norbornene-endo-2,3-dicarboxylic anhydride; bicyclo [2.2.2] oct-7-ene-2,3,5,6-tetracarboxylic dianhydride; bicyclo [2.2.1] hept-5-ene-2,3-dicarboxylic anhydride; and 5-(2,5-dioxotetrahydrofuryl)-3-methyl-3-cyclohexene-1,2-dicarboxylic anhydride. In a specific embodiment, the second COC is TOPAS 6017s (TOPAS Advanced Polymers GmbH, Raunheim, Germany).

In some embodiments, the second COC has a tensile strength ≥25 MPa. In further embodiments, the second COC has a tensile strength ≥30, 35, 40, 45, 50, 51, 52, and 53 MPa. In a specific embodiment, the second COC has a tensile strength of 54 MPa. In some embodiments, the second COC has a Young's modulus ≥200 MPa. In further embodiments, the second COC has a Young's modulus ≥250, 300, 350, 400, 450, 460, 470, and 480 MPa. In a specific embodiment, the second COC has a Young's modulus of 481. In some embodiments, the second COC has a flexural modulus ≥1000 MPa. In further embodiments, the second COC has a flexural modulus ≥1100, 1200, 1300, 1400, 1500, 1600, 1700, 1800, 1900, 2000, 2100, 2200, 2300, 2400, and 2500. In a specific embodiment, the second COC has a flexural modulus of 2530. In some embodiments, the second COC has a flexural strength ≥50 MPa. In further embodiments, the second COC has flexural strength ≥55, 60, 65, 70, 71, 72, 73, 74, and 75 MPa. In a specific embodiment, the second COC has flexural strength of 76 MPa. In some embodiments, the second COC has a flexural load ≥50 N. In further embodiments, the second COC has a flexural load ≥60, 70, 80, 90, 100, 110, 120, 121, 122, 123, 124, and 125 N. In a specific embodiment, the second COC has a flexural load of 126 N. In some embodiments, the second COC has a coefficient of thermal expansion ≤100 μm/(m° C.). In further embodiments, the second COC has a coefficient of thermal expansion ≤90, 80, 70, 60, 50, 49, 48, 47, 46, 45, 44, 43, 42, 41, and 40 μm/(m° C.). In a specific embodiment, the second COC has a coefficient of thermal expansion of 39 μm/(m° C.). All of the foregoing mechanical properties refer to measurements made by ATSM D638 and ASTM D790 standards.

In some embodiments of the methods, the second COC has a dielectric constant ≥2.10. In further embodiments, the second COC has a dielectric constant ≥2.15, 2.20, 2.25, 2.30, 2.31, 2.32, and 2.33. In a specific embodiment, the second COC has a dielectric constant of 2.335. In some embodiments, the second COC has a dissipation factor ≤0.001. In further embodiments, the second COC has dissipation factor 0.0009, 0.0008, 0.0007, 0.0006, 0.0005, 0.00049, and 0.00048. In a specific embodiment, the second COC has dissipation factor of 0.00047. In some embodiments, the second COC has a 1% weight loss temperature of ≥350° C. In further embodiments, the second COC has a 1% weight loss temperature of ≥360, 370, 380, 390, 391, 392, and 393° C. In a specific embodiment, the second COC has a 1% weight loss temperature of 394° C. In some embodiments, the second COC has a 5% weight loss temperature of ≥400° C. In further embodiments, the second COC has a 5% weight loss temperature of ≥405, 410, 415, 416, and 417° C. In a specific embodiment, the second COC has a 5% weight loss temperature of 418° C. In some embodiments, the second COC has a melt flow rate ≤200 (g/10 min) at 297° C. In further embodiments, the second COC has a melt flow rate ≤190, 180, 170, 160,150, 140, 130, 120, 110, 109, 108, 107, 106, 105, 104, 103, 102, and 101 g/(10 min). In a specific embodiment, the second COC has a melt flow rate of 100.6 g/(10 min). Melt flow rates were calculated using the method described above.

In some embodiments of the methods of forming the alloy, a second compatibilizing agent is used. For example, the second compatibilizing agent can be 1,4-bis(4,5-dihydro-2-oxazolyl) benzene or 1,3-bis (4,5-dihydro-2-oxazolyl) benzene. In a specific embodiment, such as those shown in FIGS. 3 and 4, the second compatibilizing agent is 1,4-bis(4,5-dihydro-2-oxazolyl) benzene.

### Articles of Manufacture

Articles of manufacture of many kinds can be made using various embodiments of the polymer alloys described herein. In some embodiments, an article of electronics capable of wireless communication at 1 GHz or more is provided, where the article of electronics comprises any of the polymer alloys disclosed herein. For instance, the article of electronics may be suitable for use with high frequency electronics related to Fifth Generation of Communication (5G). In further embodiments, articles of manufacture that can be made using the polymer alloys described herein include, but are not limited to, insulation materials, such as an insulator for a communications cable; printed circuit boards; cables, such as coaxial cables, wire/cable for down-hole cable, and twisted pair high speed cable for automotive; wiring; antennas; connectors and tape, such as tape wrap for electrical insulation, medical devices, electronic, medical and industrial packaging.

In a first aspect, a reaction mixture for making a compatibilizing agent is provided, the reaction mixture comprising: a first functional fluoropolymer; a first COC; a first reactive monomer; and a second reactive monomer.

In a second aspect, a method of making a compatibilizing agent for alloying a fluoropolymer with a cyclic olefin is provided, the method comprising: heating the reaction mixture of the first aspect sufficiently to melt at least the first fluoropolymer and the first COC.

In a third aspect, a method of making a compatibilizing agent for alloying a fluoropolymer with a cyclic olefin is provided, the method comprising: reacting an anhydride monomer with a first functional fluoropolymer to produce a fluoropolymer dianhydride; reacting the fluoropolymer dianhydride with a functional COC and a diamine monomer to produce the compatibilizing agent.

In a fourth aspect, a reactive polymer compatibilizer is provided that is the product of the method of the second aspect.

In a fifth aspect, a reactive polymer compatibilizer is provided that is the product of the method of the third aspect.

In a sixth aspect, a reactive polymer compatibilizer is provided, comprising: a COC group covalently bound to a linking polymer of at least one heterodimer comprising a dianhydride monomer and a diamine monomer, wherein the linking polymer is covalently bonded to a fluoropolymer group.

In a seventh aspect, a thermoplastic polymer alloy composition is provided, comprising: a second fluoropolymer; a compatibilizing agent; and a second COC.

In an eight aspect, a method of forming an alloy of a fluoropolymer and a COC is provided, the method comprising: blending a second fluoropolymer, a compatibilizing agent, and a second cyclic olefin at a temperature sufficient to melt at least the first fluoropolymer and first COC.

In a ninth aspect, an alloy of a fluoropolymer and a COC is provided that is the product of the method of the eighth aspect.

In a tenth aspect, an article of electronics capable of wireless communication at 1 GHz or more is provided, comprising: a polymer alloy of a fluoropolymer and a cyclic olefin.

### EXAMPLE

### Example 1: Alloys Using COC/PFA Compatibilizer Without Grafting

To form the COC/PFA compatibilized copolymer, a fluorinated PFA that has been sheared, bicycle [2.2.1] hept-5-ene-2,3-dicarboxylic anhydride, 4,4′-oxydianiline, and a reactive grade cyclic olefin copolymer were all added to one bag and mixed uniformly. The amounts of each chemical used in the reactive polymer compatibilizer (RPC) are shown in Table 2. The monomers used were added at one-to-one molar equivalent and totaled less than 5 wt. % for the formulation. Once the sample was thoroughly mixed, the mixture was fed at 6 kg/hr into the twin screw extruder (Leistritz ZSE 18HP). Zones 1 through 8 were heated from 315° C. to 350° C. The screw speed was kept constant at 250 RPM. The reactive extrusion process was a combination of an addition and condensation reaction that can be found in FIG. 1.

TABLE 2
Amounts of chemicals used in COC/PFA
reactive polymer compatibilizer

| | | COC | | Bicycle [2.2.1] |
|---|---|---|---|---|
| Sample | Sheared | TOPAS | 4,4′- | hept-5-ene-2,3- |
| Name | PFA | 6015s | oxydianiline | dicarboxylicanhydride |
| 42052A | 81% | 15% | 2.0% | 2.5% |
| | (810 g) | (145 g) | (20 g) | (25 g) |

After the COC/FP RPC blend was produced, the RPC was blended in a twin screw extruder with COC TOPAS 6017s, PFA or FEP, and 1,4-bis (4,5-dihydro-2-oxazolyl) benzene. The amounts of each component used in two samples are shown in Table 3 below. The sample mixture was fed at 6 to 6.5 kg/hr into the twin screw extruder. Zones 1 through 8 were heated from 315-350° C. and the screw speed was held constant at 250 RPM for PFA based samples and 300 RPM for FEP based samples. The completed reaction for the initial COC/FP blends can be found in FIG. 2.

TABLE 3
Amounts of chemicals used in COC/PFA reactive polymer compatibilizer

| | | | COC | | 1,4-bis(4,5- | 1,3-bis(4,5- |
|---|---|---|---|---|---|---|
| Sample | | | TOPAS | | dihydro-2- | dihydro-2- |
| Name | PFA | FEP | 6017s | 42052A | oxazolyl)benzene | oxazolyl)benzene |
| 42052B | 71.2% | | 17.8% | 10.0% | 1% | |
| | (1424 g) | | (356 g) | (200 g) | (20 g) | |
| 42052C | 17.8% | | 71.2% | 10.0% | 1% | |
| | (356 g) | | (1424 g) | (200 g) | (20 g) | |
| 42134A | | 17.8% | 71.2% | 10% | | 1% |
| | | (267 g) | (1068 g) | (150 g) | | (20 g) |
| 42134B | | 71.8% | 17.8% | 10% | | 1% |
| | | (1068 g) | (267 g) | (150 g) | | (20 g) |

Mechanical and thermal properties of 42052B and 42052C (as shown in Table 3 above) were tested and compared to pure PFA and COC TOPAS 6017s. Initial thermal stability testing was completed on a TA Instruments Thermogravimetric Analyzer for samples of PFA, COC TOPAS 6017s, 42042B and 42052C. Degradation temperatures were measured and are recorded in Table 4. The TGA concluded that sample 42052B was not thermally stable and was not injection moldable. All samples were measured using the following method: (1) equilibrate at 45° C., (2) ramp 10° C./min to 800° C., and (3) mark end of cycle.

TABLE 4
Degradation temperatures of PFA, COC TOPAS
6017, and COC/PFA compatibilized blends.

| | 1 wt. % Loss | 5 wt. % Loss |
|---|---|---|
| Sample Name | Temperature | Temperature |
| PFA | 465° C. | 504° C. |
| 42052B | 327° C. | 416° C. |
| 42052C | 381° C. | 420° C. |
| COC TOPAS 6017s | 394° C. | 418° C. |
| 42134A | 363° C. | 428° C. |
| 42134B | 347° C. | 431° C. |
| FEP | 456° C. | 481° C. |

Samples were gravity fed into a Sumitomo SE750DU injection molding machine. The rotating screw was heated from 600-680° F. PFA, COC TOPAS 6017s, and 42052C were molded into ASTM D638 Type V tensile bars, ASTM D790 flexural bars, and 6×6 cm plaques. Each molded part was utilized for a different characterization including mechanical properties, dynamic mechanical analysis, thermal mechanical analysis, and electrical properties.

Tensile and flexural properties were completed according to ASTM D638 and ASTM D790 standards on an Instron 5582 Universal Tester. Tensile bars were pulled at a rate of 10 mm/min until break using a 10 kN load cell. The BlueHill2 program was used to calculate Young's modulus, tensile strength, and elongation. Flexural bars were used during the 3-point flexural tests where the samples were placed on rollers 50 mm apart using a 1 kN load cell. The flexural rod was utilized to provide a load at a rate of 1.35 mm/min. The BlueHill2 program was used to calculate flexural modulus, maximum flexural strength, and maximum flexure load. Mechanical properties show that the compatibilized sample of 42052C maintains upwards of 85% of the properties from the cyclic olefin copolymer. Sample 42052C exhibits a 3-fold increase in properties compared to pure PFA. The results of these tests are shown in Table 5.

TABLE 5
Mechanical and Flexural Properties of PFA, COC
TOPAS 6017s, and COC/PFA Compatibilized Blend

| | Young's | Tensile | | Flexural | Flexural | Flexural |
|---|---|---|---|---|---|---|
| Sample | Modulus | Strength | Elongation | Modulus | Strength | Load |
| Name | (MPa) | (MPa) | (%) | (MPa) | (MPa) | (N) |
| PFA | 127.6 ± 4.6 | 21.7 ± 0.7 | 432.5 ± 26.6 | 415 ± 14.9 | 17.9 ± 0.3 | 28.8 ± 0.4 |
| 42052C | 410.5 ± 23.1 | 41.2 ± 1.6 | 17.2 ± 0.7 | 1823 ± 14.1 | 49.6 ± 2.0 | 83.9 ± 3.8 |
| COC | 481.4 ± 15.2 | 54.4 ± 3.5 | 18.4 ± 1.2 | 2530 ± 212.9 | 75.6 ± 5.2 | 126.4 ± 1.5 |
| TOPAS | | | | | | |
| 6017s | | | | | | |
| 42134A | 430.0 ± 19.9 | 48.0 ± 0.6 | 18.5 ± 0.3 | 1850 ± 12.5 | 47.8 ± 1.7 | 81.3 ± 2.2 |
| 42134B | 258.1 ± 17.1 | 24.9 ± 0.2 | 16.2 ± 0.6 | 978 ± 6.4 | 34.2 ± 0.2 | 58.3 ± 0.8 |
| FEP | 132.5 ± 7.4 | 21.9 ± 0.4 | 383.3 ± 38.3 | 424 ± 18.4 | 18.5 ± 0.5 | 30.0 ± 0.4 |

Samples underwent testing to calculate the coefficient of thermal expansion (CTE) using a TA Instruments TMA Q400. Samples were cut from a 6 x 6 cm injection molded plaque. The CTE was measured using a temperature range of 10° C. to 140/150° C. The CTE was calculated from the difference in the height of the sample over a change in temperature. The CTE for the 3 samples and pure resins are recorded in Table 6. Fluoropolymers are known for high shrinkage and expansion rates at elevated temperatures. Sample 42052C and 42134A showed a decreased CTE for the measured temperature range compared to pure PFA and FEP. However, sample 42134B, a fluoropolymer rich sample, still exhibited an extremely high CTE as a resultant of the high fluoropolymer concentration. All samples were run using the following method: (1) force 0.100 N, (2) equilibrate at 35.00° C., (3) isothermal for 5.00 min, (4) mark end of cycle 0, (5) isothermal for 5.00 min, (6) ramp 5.00° C./min to 100.00° C., (7) isothermal for 3.00 min, (8) mark end of cycle 1, (9) ramp 10.00° C./min to 0.00° C., (10) mark end of cycle 2, (11) ramp 5.00° C./min to 175.00° C., and (12) end of method.

TABLE 6
Coefficient of thermal expansion for PFA, COC
TOPAS 6017s, and COC/PFA compatibilized blends.

| | CTE |
|---|---|
| Sample Name | (μm/m*° C.) |
| PFA | 139.0 |
| 42052C | 66.6 |
| COC TOPAS 6017s | 38.9 |
| 42134A | 68.0 |
| 42134B | 217.9 |
| FEP | 291.4 |

Dielectric properties were measured on 6 x 6 cm injection molded plaques using a Keysight P9374A PNA. The data was analyzed using NIST SplitC software. The dielectric constant and dissipation factor were recorded at 17 GHz and are shown in Table 7. Sample 42052C exhibited a dielectric constant slightly higher than pure PFA but lower than that of pure COC and it exhibited a dissipation factor less than 0.001 which is superior to pure fluoropolymers.

TABLE 7
Dielectric constant and dissipation factor for PFA,
COC 6017s, and COC/PFA Compatibilized Blend.

| Sample Name | Dₖ | D_{f} |
|---|---|---|
| PFA | 2.053 | 0.001 |
| 42052C | 2.298 | 0.00094 |
| COC TOPAS 6017s | 2.335 | 0.00047 |
| 42134A | 2.297 | 0.00067 |
| 42134B | 2.165 | 0.00067 |
| FEP | 2.057 | 0.0004 |

### Example 2: Alloys Using COC/PFA Compatibilizer With Grafted Functional Groups

A second approach involved the grafting of a dianhydride onto the cyclic olefin copolymer utilizing a high temperature stable dialkyl peroxide. This step is believed to increase the reactive groups available to create a copolymer of COC and PFA. The grafting was controlled by increasing the amount of dianhydride (bicycle [2.2.1]hept-5-ene-2,3-dicarboxylic anhydride, or “BCDA”) introduced into the reactive extrusion process. These compositions are shown in Table 8. The materials were combined in a plastic bag and manually mixed. The extruder profile is shown in Table 9. The samples were fed into the TSE at a rate of 4.5 kg/hr with a screw speed of 300 RPM. The grafting of the COC is an addition reaction.

TABLE 8
Sample compositions for grafted COC

| | COC TOPAS | | Dialkyl |
|---|---|---|---|
| Sample Name | 6015s | BCDA | Peroxide |
| 42126A | 98.9% | 1% | 0.1% |
| | (1978 g) | (20 g) | (2 g) |
| 42126B | 96.9% | 3% | 0.1% |
| | (1938 g) | (60 g) | (2 g) |
| 42126C | 94.9% | 5% | 0.1% |
| | (1898 g) | (100 g) | (2 g) |

TABLE 9
temperature profiles used for grafting of COC

| Zone | 1 | 2 | 3 | 4 | 5 | 6 | 7 | 8 |
|---|---|---|---|---|---|---|---|---|
| Profile (° C.) | 230 | 235 | 235 | 240 | 245 | 250 | 255 | 260 |

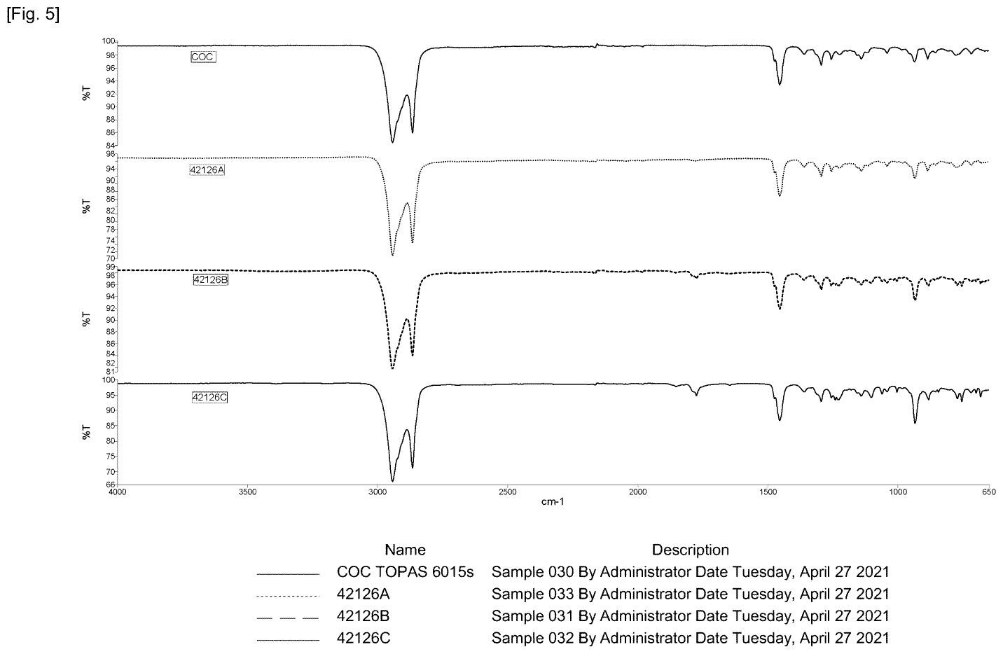

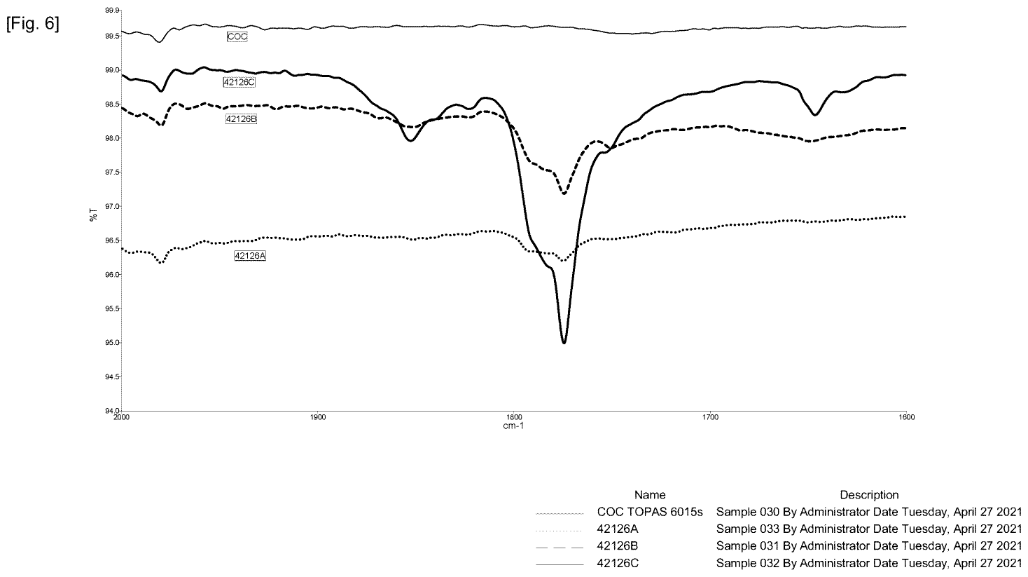

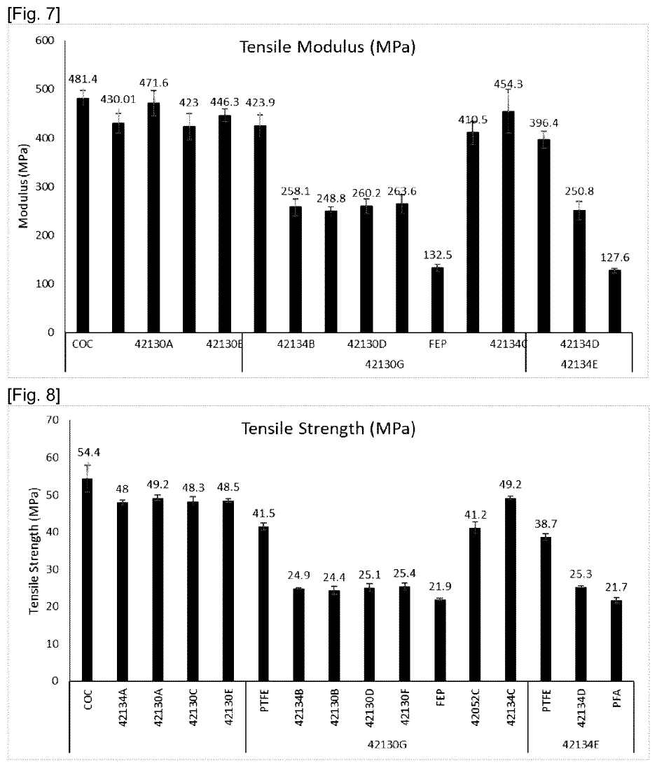

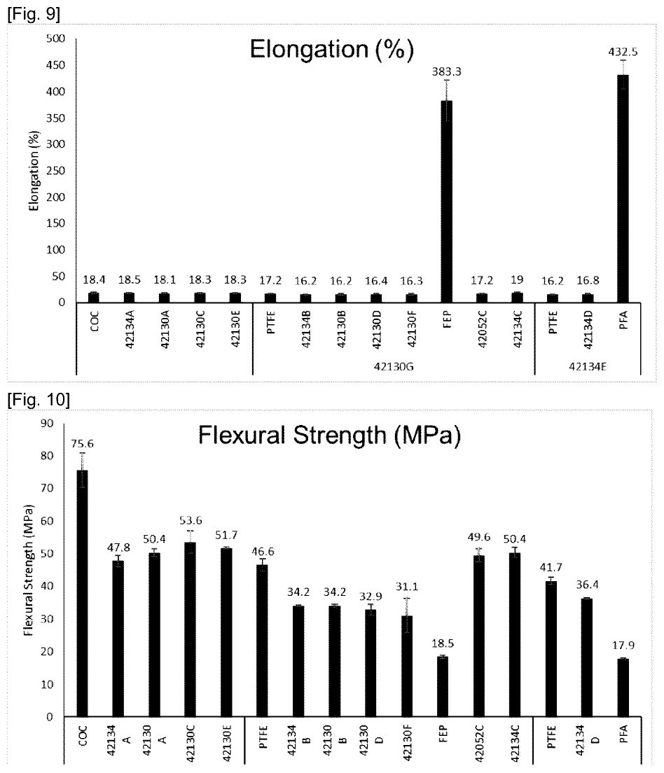

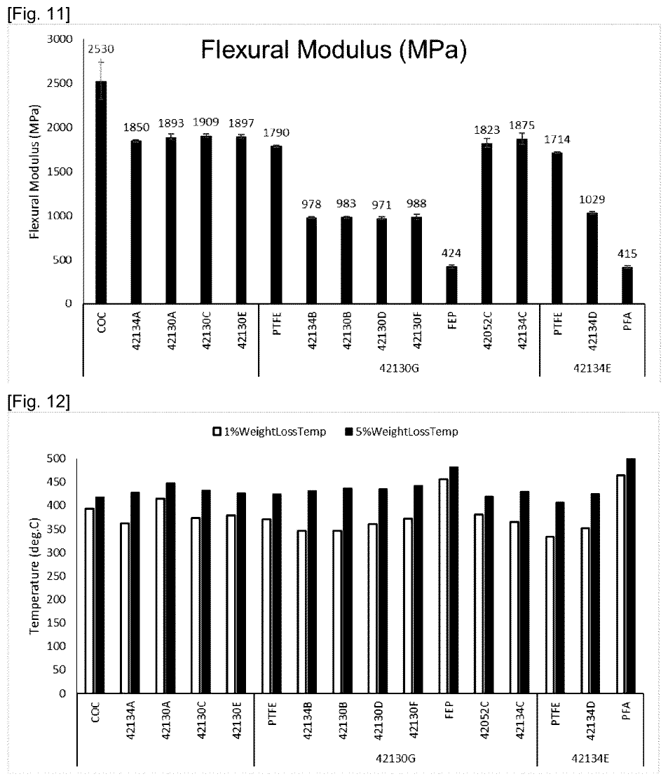

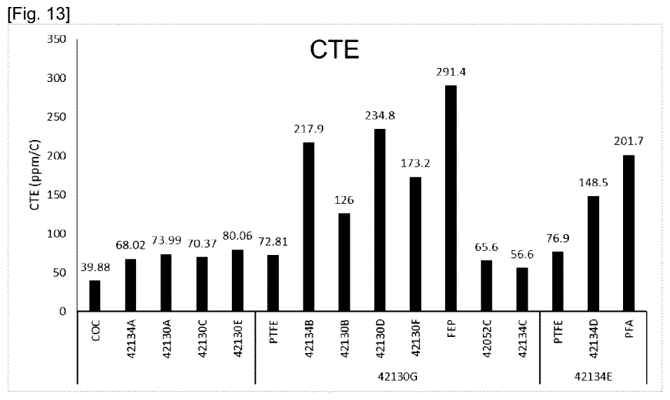

The grafting density was determined through FTIR characterization. Pellets of each sample were pressed at elevated temperatures using a heated Carver press to produce a flat sample area. Using the Universal ATR Sampling Accessory, a Perkin Elmer Spectrum 100 FT-IR spectrometer was used to characterize each sample. The transmission plots of each sample are shown in FIG. 5. The FTIR spectrums show the formation of new bands responding to the cyclic anhydrides that can be found clearly at 1853 cm⁻¹ and 1775 cm⁻¹. Generally, the peaks become more prominent with the increase in the cyclic anhydride concentration which can be seen in FIG. 6.

After the confirmation of successful grafting, the grafted COC were used to create a new generation of RPC. The compositions of the three RPCs can be found in Table 10. This reaction is a condensation reaction and can be found in FIG. 3. The materials were mixed in a plastic bag and fed into the TSE at a rate of 6.5 kg/hr with a screw speed of 300 RPM. After successful extrusion of the RPCs the pellets were dried overnight in an oven at 100° C. The compositions for the final COC/FP blends are shown in Table 11. Materials were mixed in a plastic bag and fed into the TSE at a rate of 6.5 kg/hr with a screw speed of 300 RPM. The temperature profile for both the RPC extrusion and COC/FP blend extrusion for the TSE can be found in Table 12. The chemistry for the final blend can be found in FIG. 4.

TABLE 10
Sample compositions for grafted COC reactive polymer compatibilizer.

| | | Grafted | Grafted | Grafted | | |
|---|---|---|---|---|---|---|
| Sample | Sheared | COC | COC | COC | | 4,4- |
| Name | PFA | 42126A | 42126B | 42126C | 6FDA | oxydianiline |
| 42128A | 76.35% | 19.09% | | | 3.11% | 1.45% |
| | (1145.25 g) | (286.35 g) | | | (46.65 g) | (21.75 g) |
| 42128B | 76.35% | | 19.09% | | 3.11% | 1.45% |
| | (1145.25 g) | | (286.35 g) | | (46.65 g) | (21.75 g) |
| 42128C | 76.35% | | | 19.09% | 3.11% | 1.45% |
| | (1145.25 g) | | | (286.35 g) | (46.65 g) | (21.75 g) |

TABLE 11
Sample compositions for COC/FP compatibilized blend.

| | | | | | | | | 1,3-bis(4,5- |
|---|---|---|---|---|---|---|---|---|
| | COC | | | | | | | dihydro-2- |
| Sample | TOPAS | | | | | | PTFE | oxazolyl) |
| Name | 6017s | FEP | PFA | 42128A | 42128B | 42128C | L5F | benzene |
| 42130A | 71.2% | 17.8% | | 10.0% | | | | 1% |
| | (1068 g) | (267 g) | | (150 g) | | | | (15 g) |
| 42130B | 17.8% | 71.2% | | 10.0% | | | | 1% |
| | (267 g) | (1068 g) | | (150 g) | | | | (15 g) |
| 42130C | 71.2% | 17.8% | | | 10.0% | | | 1% |
| | (1068 g) | (267 g) | | | (150 g) | | | (15 g) |
| 42130D | 17.8% | 71.2% | | | 10.0% | | | 1% |
| | (267 g) | (1068 g) | | | (150 g) | | | (15 g) |
| 42130E | 71.2% | 17.8% | | | | 10.0% | | 1% |
| | (1068 g) | (267 g) | | | | (150 g) | | (15 g) |
| 42130F | 17.8% | 71.2% | | | | 10.0% | | 1% |
| | (267 g) | (1068 g) | | | | (150 g) | | (15 g) |
| 42130G | 67.2% | 16.8% | | | | 10.0% | 5% | 1% |
| | (1008 g) | (252 g) | | | | (150 g) | (75 g) | (15 g) |
| 42134C | 71.2% | | 17.8% | | | 10.0% | | 1% |
| | (1068 g) | | (267 g) | | | (150 g) | | (15 g) |
| 42134D | 17.8% | | 71.2% | | | 10.0% | | 1% |
| | (267 g) | | (1068 g) | | | (150 g) | | (15 g) |
| 42134E | 67.2% | | 16.8% | | | 10.0% | 5% | 1% |
| | (1008 g) | | (252 g) | | | (150 g) | (75 g) | (15 g) |

TABLE 12
Temperature profiles used for grafted COC Reactive
polymer compatibilizer and COC/FP blends

| Zone | 1 | 2 | 3 | 4 | 5 | 6 | 7 | 8 |
|---|---|---|---|---|---|---|---|---|
| Profile (° C.) | 315 | 320 | 330 | 335 | 340 | 350 | 350 | 345 |

After the successful compounding, the thermal stability of each COC/FP blend was tested using thermogravimetric analysis. Degradation temperatures were measured at 1 wt. % and 5 wt. % and can be found in Table 13. Overall, it appears that FEP based samples are thermally more stable than PFA based samples which all lead to generally lower 1% weight loss temperatures. A higher grafting density of COC has a direct impact on the degradation temperatures of the blends. The sample 42130A has a 1 wt. % loss at 414° C. and a 5 wt. % loss at 448° C. with a COC that has a 1% grafting density. As the grafting density is increased to 3% and 5% the 1 wt. % loss temperatures decrease to 374° C. and 379° C. and the 5 wt. % loss temperatures decrease to 432° C. and 428° C. respectively for blends of 42130C and 42130E. Also, the inclusion of PTFE in sample 42134C decreased the 1% and 5% weight loss temperatures by 20° C. All samples were measured using the following method: (1) equilibrate at 45° C., (2) ramp 10° C./min to 800° C., and (3) mark end of cycle.

TABLE 13
Degradation temperatures for COC/FP blends.

| | 1 wt. % Loss | 5 wt. % Loss |
|---|---|---|
| Sample Name | Temperature | Temperature |
| COC TOPAS | 394° C. | 418° C. |
| 6017s | | |
| 42130A | 414° C. | 448° C. |
| 42130B | 347° C. | 437° C. |
| 42130C | 374° C. | 432° C. |
| 42130D | 361° C. | 435° C. |
| 42130E | 379° C. | 428° C. |
| 42130F | 371° C. | 442° C. |
| 42130G | 371° C. | 424° C. |
| 42134C | 365° C. | 430° C. |
| 42134D | 352° C. | 425° C. |
| 42134E | 334° C. | 407° C. |

Samples were gravity fed into a Sumitomo SE750DU injection molding machine. The rotating screw was heated from 600-680° F. PFA, COC TOPAS 6017s, and COC/FP blends were molded into ASTM D638 Type V tensile bars, ASTM D790 flexural bars, and 6×6 cm plaques. Each molded part was utilized for a different characterization including mechanical properties, dynamic mechanical analysis, thermal mechanical analysis, and electrical properties.

Tensile and flexural properties were completed according to ASTM D638 and ASTM D790 standards on an Instron 5582 Universal Tester. Tensile bars were pulled at a rate of 10 mm/min until break using a 10 kN load cell. The BlueHill2 program was used to calculate Young's modulus, tensile strength, and elongation. Flexural bars were used during the 3-point flexural tests where the samples were placed on rollers 50 mm apart using a 1 kN load cell. The flexural rod was utilized to provide a load at a rate of 1.35 mm/min. The BlueHill2 program was used to calculate flexural modulus, maximum flexural strength, and maximum flexure load. The mechanical properties for COC/FP blends are recorded in Table 14. Samples that were majority COC took on the properties of the COC including increased modulus, tensile strength, and elongation. Blends that are majority fluoropolymer do see a 2× increase in Young's modulus or elastic modulus resulting in a stiffer copolymer compared to FEP or PFA. The inclusion of PTFE decreases the tensile strength by 7 MPa for COC/FEP blend and by 10.5 MPa for the COC/PFA blend. This is suggesting that the PTFE filler, used for increased flame retardancy, breaks up the alignment of the polymer and decreases the interactions between the COC and FP and act as stress points in the blend weakening the material.

TABLE 14
Mechanical properties for COC/FP blends.

| | Young's | Tensile | | Flexural | Flexural | Flexural |
|---|---|---|---|---|---|---|
| Sample | Modulus | Strength | Elongation | Modulus | Strength | Load |
| Name | (MPa) | (MPa) | (%) | (MPa) | (MPa) | (N) |
| COC TOPAS | 481.4 ± 15.2 | 54.4 ± 3.5 | 18.4 ± 1.2 | 2530 ± 212.9 | 75.6 ± 5.2 | 126.4 ± 1.5 |
| 6017s | | | | | | |
| 42130A | 471.6 ± 26.1 | 49.2 ± 0.8 | 18.1 ± 0.7 | 1893 ± 33.7 | 50.4 ± 1.1 | 86.1 ± 2.0 |
| 42130B | 248.8 ± 10.0 | 24.4 ± 1.1 | 16.2 ± 0.9 | 983 ± 14.0 | 34.2 ± 0.4 | 58.8 ± 0.6 |
| 42130C | 423.0 ± 27.2 | 48.3 ± 1.2 | 18.3 ± 0.4 | 1909 ± 21.0 | 53.6 ± 3.4 | 90.7 ± 5.7 |
| 42130D | 260.2 ± 14.6 | 25.1 ± 1.0 | 16.4 ± 0.6 | 971 ± 15.7 | 32.9 ± 1.7 | 56.5 ± 2.6 |
| 42130E | 446.3 ± 12.8 | 48.5 ± 0.5 | 18.3 ± 0.6 | 1897 ± 23.1 | 51.7 ± 0.4 | 88.2 ± 0.4 |
| 42130F | 263.6 ± 19.2 | 25.4 ± 0.9 | 16.3 ± 0.8 | 988 ± 31.1 | 31.1 ± 5.2 | 53.8 ± 9.3 |
| 42130G | 423.9 ± 23.2 | 41.5 ± 0.9 | 17.2 ± 0.3 | 1790 ± 9.7 | 46.6 ± 1.9 | 79.3 ± 3.0 |
| 42134C | 454.3 ± 45.4 | 49.2 ± 0.5 | 19.0 ± 0.5 | 1875 ± 57.6 | 50.4 ± 1.6 | 86.1 ± 2.6 |
| 42134D | 250.8 ± 18.8 | 25.3 ± 0.3 | 16.8 ± 1.0 | 1029 ± 15.5 | 36.4 ± 0.2 | 61.4 ± 0.5 |
| 42134E | 396.4 ± 17.7 | 38.7 ± 0.9 | 16.2 ± 0.5 | 1714 ± 8.4 | 41.7 ± 1.1 | 70.6 ± 1.3 |
| FEP | 132.5 ± 7.4 | 21.9 ± 0.4 | 383.3 ± 38.3 | 424 ± 18.4 | 18.5 ± 0.5 | 30.0 ± 0.4 |
| PFA | 127.6 ± 4.6 | 21.7 ± 0.7 | 432.5 ± 26.6 | 415 ± 14.9 | 17.9 ± 0.3 | 28.8 ± 0.4 |

Samples underwent testing to calculate the coefficient of thermal expansion (CTE) using a TA Instruments TMA Q400. Samples were cut from a 6 x 6 cm injection molded plaque. The CTE was measured using a temperature range of 10° C. to 140/150° C. The CTE was calculated from the difference in the height of the sample over a change in temperature. The CTE for the 10 samples and pure resins are recorded in Table 15. Samples that are COC rich regardless of the fluoropolymer exhibit CTE under 100 (μm/m*° C.). Samples that are fluoropolymer rich still exhibited an extremely high CTE. The addition of PTFE did not uniformly impact the CTE for the blends. When PTFE was introduced to a COC/FEP blend the CTE decreased by 8 (μm/m*° C.) but when introduced to a COC/PFA blend the CTE increased by almost 20 (μm/m*° C.). All samples were run using the following method: (1) force 0.100 n, (2) equilibrate at 35.00° C., (3) isothermal for 5.00 min, (4) mark end of cycle 0, (5) isothermal for 5.00 min, (6) ramp 5.00° C./min to 100.00° C., (7) isothermal for 3.00 min, (8) mark end of cycle 1, (9) ramp 10.00° C./min to 0.00° C., (10) mark end of cycle 2, (11) ramp 5.00° C./min to 175.00° C., and (12) end of method.

TABLE 15
Coefficient of thermal expansion for COC/FP blends.

| | | COC | CTE |
|---|---|---|---|
| Sample Name | Fluoropolymer | Concentration | (μm/m*° C.) |
| COC TOPAS | — | — | 39.9 |
| 6017s | | | |
| 42130A | FEP | High | 74.0 |
| 42130B | FEP | Low | 126.0 |
| 42130C | FEP | High | 70.4 |
| 42130D | FEP | Low | 243.8 |
| 42130E | FEP | High | 80.06 |
| 42130F | FEP | Low | 173.2 |
| 42130G | FEP | High | 72.8 |
| 42134C | PFA | High | 56.6 |
| 42134D | PFA | Low | 148.5 |
| 42134E | PFA | High | 76.9 |
| FEP | — | — | 291.4 |
| PFA | — | — | 139.0 |

The melt flow rate (MFR) of selected FEP blends were measured following ASTM D1238. Selected blends MFR were measured at 297° C. with a 5-minute dwell time and a 5 kg weight. Measured MFRs can be found in the following table. For COC/FEP blends with a majority COC the MFR increases with the grafting density of the COC in the RPC. The grafting density does not have the same impact on fluoropolymer rich blends. Introducing PTFE into the COC/FEP blend decreased the MFR by 30 g/10 min.

TABLE 16
Melt flow rate for COC/FEP Blends

| | COC | MFR (g/10 min) |
|---|---|---|
| Sample Name | Concentration | at 297° C. |
| COC TOPAS | — | 100.6 |
| 6017s | | |
| 42130A | High | 79.5 |
| 42130B | Low | 24.6 |
| 42130C | High | 85.8 |
| 42130D | Low | 22.8 |
| 42130E | High | 91.9 |
| 42130F | Low | 25.9 |
| 42130G | High | 61.9 |

Dielectric properties were measured on 6×6 cm injection molded plaques using a Keysight P9374A PNA. The data was analyzed using NIST SplitC software. The dielectric constant and dissipation factor were recorded at 17 GHz and are shown in Table 17. Samples that are majority COC exhibit an increased dielectric constant closer to that of pure COC. However, samples that are fluoropolymer rich have a decreased dielectric constant at approximately 2.1. The dissipation factor is positively influenced by the addition of COC with all but one blend measuring below 0.001 which is an improvement compared to fluoropolymers. The addition of PTFE does not impact negatively the dissipation factor, but it does improve the dielectric constant by lowering it from 2.301 to 2.295 for the COC/FEP blend and from 2.304 to 2.295 for the COC/PFA blend.

TABLE 17
Dielectric properties for select COC/FP blends.

| | | COC | | |
|---|---|---|---|---|
| Sample Name | Fluoropolymer | Concentration | Dₖ | D_{f} |
| COC TOPAS | — | — | 2.335 | 0.00047 |
| 6017s | | | | |
| 42130E | FEP | High | 2.301 | 0.00078 |
| 42130F | FEP | Low | 2.173 | 0.00080 |
| 42130G | FEP | High | 2.295 | 0.00076 |
| 42134C | PFA | High | 2.304 | 0.00082 |
| 42134D | PFA | Low | 2.168 | 0.0013 |
| 42134E | PFA | High | 2.295 | 0.00089 |
| FEP | — | — | 2.057 | 0.0004 |

TABLE 18
Comprehensive Summary Table of COC/FP Blends

| | | Average | Measurement | | | | | | | Flexural | |
|---|---|---|---|---|---|---|---|---|---|---|---|
| | Sample | Thickness, | Frequency, | | | CTE | TS | TM | TD | Modulus | Tg |
| | ID | mm | Hz | ετ | Loss | (ppm) | (MPa) | (MPa) | (1%, 5%) | (MPa) | (° C.) |
| COC/FEP | 42130E_1 | 2.012 | 1.6870E+09 | 2.301 | 7.78E−04 | 80.6 | 48.5 | 446.3 | 378.9° C., | 1897 | 153 |
| (80/20) | | | | | | | | | 427.5° C. | | |
| COC/FEP | 42130E_2 | 2.003 | 1.6886E+10 | 2.302 | 7.89E−04 | | | | | | |
| (80/20) | | | | | | | | | | | |
| COC/FEP | 42130F_1 | 2.111 | 1.7002E+10 | 2.173 | 7.95E−04 | 173.2 | 25.4 | 263.6 | 371.4° C., | 988 | 59.9/150.9 |
| (20/80) | | | | | | | | | 442.4° C. | | |
| COC/FEP | 42130F_2 | 2.096 | 1.7023E+10 | 2.172 | 8.03E−04 | | | | | | |
| (20/80) | | | | | | | | | | | |
| COC/FEP | 42130G_1 | 2.022 | 1.6876E+10 | 2.295 | 7.59E−04 | 72.81 | 41.5 | 423.9 | 371.4° C., | 1790 | 153.8 |
| (80/20) + | | | | | | | | | 442.4° C. | | |
| 5% PTFE-L5f | | | | | | | | | | | |
| COC/FEP | 42130G_2 | 2.014 | 1.6884E+10 | 2.296 | 7.56E−04 | | | | | | |
| (80/20) + | | | | | | | | | | | |
| 5% PTFE-L5f | | | | | | | | | | | |
| COC/PFA | 42134C_1 | 2.018 | 1.6864E+10 | 2.304 | 8.18E−04 | 56.6 | 49.2 | 454.3 | 364.5° C., | | 151.2 |
| (80/20) | | | | | | | | | 430.3° C. | | |
| COC/PFA | 42134C_2 | 2.006 | 1.6877E+13 | 2.305 | 8.21E−04 | 148.5 | 25.3 | 250.8 | 351.6° C., | 971 | 149 |
| (80/20) | | | | | | | | | 424.9° C. | | |
| PFA/COC | 42134D_1 | 2.024 | 1.7120E+10 | 2.168 | 1.27E−03 | | | | | | |
| (80/20) | | | | | | | | | | | |
| PFA/COC | 42134D_2 | 2.020 | 1.7117E+10 | 2.172 | 1.26E−03 | | | | | | |
| (80/20) | | | | | | | | | | | |
| | 42130E_1b | 2.017 | 1.6882E+10 | 2.295 | 8.92E−04 | | | | | | |
| | 42130E_1b | 2.016 | 1.6883E+10 | 2.295 | 8.83E−04 | | | | | | |
| | FEP | | | | | 291.4 | 21.7 | 132.5 | 456.1° C., | 424 | 60.3 |
| | | | | | | | | | 481.7° C. | | |
| | PFA | | | | | 201.7 | 21.9 | 127.6 | 465° C., | 415 | 66 |
| | | | | | | | | | 504.2° C. | | |

### Conclusions

It is to be understood that any given elements of the disclosed embodiments of the invention may be embodied in a single structure, a single step, a single substance, or the like. Similarly, a given element of the disclosed embodiment may be embodied in multiple structures, steps, substances, or the like. The foregoing description and accompanying drawings illustrate and describe certain processes, machines, manufactures, and compositions of matter, some of which embody the invention(s). Such descriptions or illustrations are not intended to limit the scope of what can be claimed, and are provided as aids in understanding the claims, enabling the making and use of what is claimed, and teaching the best mode of use of the invention(s). If this description and accompanying drawings are interpreted to disclose only a certain embodiment or embodiments, it shall not be construed to limit what can be claimed to that embodiment or embodiments. Any examples or embodiments of the invention described herein are not intended to indicate that what is claimed must be coextensive with such examples or embodiments. Where it is stated that the invention(s) or embodiments thereof achieve one or more objectives, it is not intended to limit what can be claimed to versions capable of achieving all such objectives. Any statements in this description criticizing the prior art are not intended to limit what is claimed to exclude any aspects of the prior art. Additionally, the disclosure shows and describes certain embodiments of the processes, machines, manufactures, compositions of matter, and other teachings disclosed, but it is to be understood that the teachings of the present disclosure are capable of use in various other combinations, modifications, and environments and is capable of changes or modifications within the scope of the teachings as expressed herein. Any section headings herein are provided only for consistency with the suggestions of 37 C.F.R. § 1.77 or otherwise to provide organizational queues. These headings shall not limit or characterize the invention(s) set forth herein.

1. A reaction mixture for making a compatibilizing agent, the reaction mixture comprising:
(a) a first functional fluoropolymer;
(b) a first cyclic olefin copolymer;
(c) a first reactive monomer; and
(d) a second reactive monomer.

2. The reaction mixture of claim 1, wherein the cyclic olefin copolymer comprises a functional group.

3. The reaction mixture of claim 1, wherein the first cyclic olefin copolymer is an anhydride.

4. The reaction mixture of claim 1, wherein the first cyclic olefin copolymer is a dianhydride.

5. The reaction mixture of claim 1, wherein the first cyclic olefin copolymer is a dianhydride that is a product of a process comprising reacting bicyclo [2.2.1]hept-5-ene-2,3-dicarboxylic anhydride with a cyclic olefin copolymer.

6. The reaction mixture of claim 1, wherein the first cyclic olefin copolymer is a dianhydride that is a product of a process comprising reacting an anhydride with a cyclic olefin copolymer catalyzed by a peroxide.

7. The reaction mixture of claim 1, wherein the first cyclic olefin copolymer is a dianhydride that is a product of a process comprising reacting bicyclo [2.2.1]hept-5-ene-2,3-dicarboxylic 5-ene-2,3-dicarboxylic anhydride with a cyclic olefin copolymer catalyzed by a peroxide.

8. The reaction mixture of claim 1, comprising a peroxide catalyst capable of catalyzing functionalization of the first cyclic olefin copolymer by an anhydride.

9. The reaction mixture of claim 1, comprising a peroxide catalyst, and wherein the first cyclic olefin copolymer is not a functional cyclic olefin copolymer.

10. The reaction mixture claim 1, wherein the first monomer is a diamine.

11. The reaction mixture of claim 1, wherein the first monomer is a dianiline.

12. The reaction mixture of claim 1, wherein the second monomer is an anhydride.

13. The reaction mixture of claim 1, wherein the second monomer is a dicarboxylic anhydride.

14. The reaction mixture of claim 1, wherein the second monomer is an unsaturated cyclic dianhydride.

15. The reaction mixture claim 1, wherein the second monomer is bicyclo [2.2.1]hept-5-ene-2,3-dicarboxylic anhydride.

16. The reaction mixture of claim 1, wherein the second monomer is present at about 2.5-30% w/w.

17. The reaction mixture of claim 1, wherein the first cyclic olefin copolymer has a tensile strength ≥25 MPa.

18. The reaction mixture of claim 1, wherein the first cyclic olefin copolymer has a Young's modulus ≥200 MPa.

19. The reaction mixture of claim 1, wherein the first cyclic olefin copolymer has a flexural modulus ≥1000 MPa.

20. The reaction mixture of claim 1, wherein the first cyclic olefin copolymer has a flexural strength ≥50 MPa.

21. The reaction mixture of claim 1, wherein the first cyclic olefin copolymer has a flexural load ≥50 N.

22. The reaction mixture of claim 1, wherein the first cyclic olefin copolymer has a coefficient of thermal expansion ≤100 μm/(m° C.).

23. The reaction mixture of claim 1, wherein the first cyclic olefin copolymer has a dielectric constant ≥2.1.

24. The reaction mixture of claim 1, wherein the first cyclic olefin copolymer has dissipation factor ≤0.001.

25. The reaction mixture of claim 1, wherein the first cyclic olefin copolymer has a 1% weight loss temperature of ≥350° C.

26. The reaction mixture of claim 1, wherein the first cyclic olefin copolymer has a 5% weight loss temperature of ≥400° C.

27. The reaction mixture of claim 1, wherein the first cyclic olefin copolymer has a melt flow rate ≤200 (g/10 min) at 297° C.

28. The reaction mixture of claim 1, wherein the first fluoropolymer has been sheared.

29. The reaction mixture of claim 1, wherein the first fluoropolymer is one or more of:
perfluoroalkoxy alkane (PFA), fluorinated ethylene propylene (FEP),
polytetrafluoroethylene (PTFE), ethylene tetra-fluoroethylene (ETFE),
polyvinylidene fluoride (PVDF), and a terpolymer of ethylene, tetrafluoroethylene,
hexafluoropropylene (EFEP), ethylene chlorotrifluoroethylene (ECTFE),
polychlorotrifluoroethylene (PCTFE), terpolymer of tetrafluoroethylene-hexafluoropropylene-vinylidene fluoride (THV), and tetrafluoroethylene and vinylidene fluoride copolymer (VT).

30. The reaction mixture of claim 1, wherein the first fluoropolymer is present at about 70-80% w/w can be present from 1%-99%.

31. The reaction mixture of claim 1, wherein the first monomer is 4,4′-oxydianiline.

32. The reaction mixture of claim 1, wherein the first monomer is present from 1-25% w/w.

33. The reaction mixture of claim 1, wherein the second monomer is 4,4′-(hexafluoroisopropylidene) diphthalic anhydride (6FDA).

34. The reaction mixture of claim 1, wherein the second monomer is present from 1-25% w/w.

35. The reaction mixture of claim 1, wherein the first cyclic olefin copolymer comprises one or more of: maleic anhydride, cis-4-cyclohexene-1,2-dicarboxylic anhydride; trans-1,2,3,6-tetrahydrophthalic acid; 5-methyl-3A,4,7,7A-tetrahydro-isobenzofuran-1,3-dione; endo-bicyclo [2.2.2]oct-5-ene-2,3-dicarboxylic anhydride; cis-5-norbornene-endo-2,3-dicarboxylic anhydride; bicyclo [2.2.2]oct-7-ene-2,3,5,6-tetracarboxylic dianhydride; bicyclo [2.2.1]hept-5-ene-2,3-dicarboxylic anhydride; and 5-(2,5-dioxotetrahydrofuryl)-3-methyl-3-cyclohexene-1,2-dicarboxylic anhydride.
